(19) United States
(12) Patent Application Publication
(10) Pub. No.: US 2023/0020854 A1
(43) Pub. Date: Jan. 19, 2023

(54) POWER ELECTRONICS ON-LOAD TAP CHANGER WITH A REDUCED NUMBER OF TAPS

(71) Applicant: Hitachi Energy Switzerland AG, Baden (CH)

(72) Inventors: Nan CHEN, Västerås (SE); Yuhei OKAZAKI, Västerås (SE); Roberto ALVES, Västerås (SE); Alireza NAMI, Västerås (SE)

(73) Assignee: Hitachi Energy Switzerland AG, Baden (CH)

(21) Appl. No.: 17/784,659

(22) PCT Filed: Dec. 15, 2020
(86) PCT No.: PCT/EP2020/086160

§ 371 Date: Jun. 12, 2022

(30) Foreign Application Priority Data
Dec. 17, 2019 (EP) 19217261.7

(51) Int. Cl. H01F 29/04; H01F 29/02; H01H 9/00

(52) U.S. Cl. CPC H01F 29/04; H01F 29/025; H01H 9/0005

(57) ABSTRACT

An inductive power device with variable active winding size, comprises first circuitry, multiple winding segments and switching circuitry operable to connect selectable combinations of the winding segments serially to the first circuitry via taps. At least two of the winding segments are of unequal size, wherein said at least two winding segments are provided as sequential portions of a total winding magnetically coupled to an opposite winding, wherein the winding segments have uniform polarity with respect to said magnetic coupling. The switching circuitry comprises an arrangement of semiconductor switches which are operable to include or exclude each winding segment independently. In an embodiment, the arrangement of switches comprises at least one half-bridge structure.

### CROSS REFERENCE TO RELATED APPLICATIONS

This application is a 35 U.S.C. § 371 national stage application of PCT International Application No. PCT/EP2020/086160 filed on Dec. 15, 2020, which in turn claims foreign priority to European Patent Application No. 19217261.7, filed on Dec. 17, 2019, the disclosures and content of which are incorporated by reference herein in their entirety.

### TECHNICAL FIELD

The present disclosure relates to the field of inductive power devices and in particular to a transformer with variable turns ratio.

### BACKGROUND

In the field of inductive power devices with two magnetically coupled windings, it is known to provide one of the windings with more than two connection points—historically called taps—so that the active winding size can be made variable and, hence, different turns ratios can be obtained. An on-load tap changer (OLTC) allows the active taps to be re-selected in an energized state of the inductive power device.

As one example, WO2009105734A2 discloses a power conversion system including an input terminal that is arranged to be connected to a voltage source, a transformer having a first winding connected to the input terminal and a second winding connected to an output terminal of the power conversion system. Either the first winding or the second winding is provided with at least three taps that are arranged to divide the first winding or the second winding into at least two sub-windings. At least one tap switch is connected to the at least two sub-windings and is controlled by a control circuit, which is arranged to control the at least one tap switch to control the turns ratio of the transformer. U.S. Pat. No. 4,220,911 A discloses a transformer comprising a first circuitry, winding segments and switching circuitry, where the winding segments can be of unequal size. A similar construction is shown in DE 102012202105 A1.

Building OLTCs from power electronics components, such as semi-conductor switches, is an attractive option. However, the total device cost of such OLTCs depends strongly on the quantity of installed semiconductor components. It is a problem to limit the component cost of OLTCs without sacrificing their versatility. In particular, users may expect that an OLTC offers a large range of available active winding sizes (or equivalently, a large range of available turns ratios) while wherein consecutive winding sizes differ by just a small step over the whole range.

### SUMMARY

It is an object of the present invention to propose an OLTC which has a specified number of available active winding sizes and can be realized at a limited component cost. It is another object to propose an OLTC with a reduced number of taps for realizing a specified range of winding sizes, thereby realizing a specified range of turns ratios. It is a further object to propose an inductive power device comprising such OLTC.

The invention according to claim 1 addresses the above object. The dependent claims define advantageous embodiments of the invention.

An inductive power device includes first circuitry, at least two winding segments and switching circuitry which is operable to connect selectable combinations of said winding segments in series to said first circuitry. The first circuitry can have any function or structure. According to an embodiment of the invention, at least some of the winding segments are of unequal size.

Because some of the winding segments are of unequal size, the maximal step between consecutive active winding sizes can be maintained small over the full range of available active winding sizes. To illustrate, combinations of winding segments having respective sizes of 100 and 200 turns cover the range [0, 300] with a step of 100 turns. Similarly, winding segment sizes M, 2M and 4M, where M is an arbitrary integer, can be combined to cover the range [0, 7M] with a step of M.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise.

### BRIEF DESCRIPTION OF THE DRAWINGS

Embodiments of the invention will now be described by way of example, with reference to the accompanying drawings, on which:

FIG. 1 is a schematic circuit diagram of an inductive power device according to an embodiment; and

FIG. 2 is a detailed view of example switching circuitry, which is suitable for use in the inductive power device shown in FIG. 1, as well as winding segments and taps.

### DETAILED DESCRIPTION

The present invention will be described more fully with reference to the accompanying drawings, on which certain embodiments of the invention are shown. The invention may, however, be embodied in many different forms and these embodiments should not be construed as limiting; rather, they are provided by way of example so that this disclosure will be thorough and complete, and to fully convey the scope of all aspects of invention to those skilled in the art. Like numbers refer to like elements throughout the description.

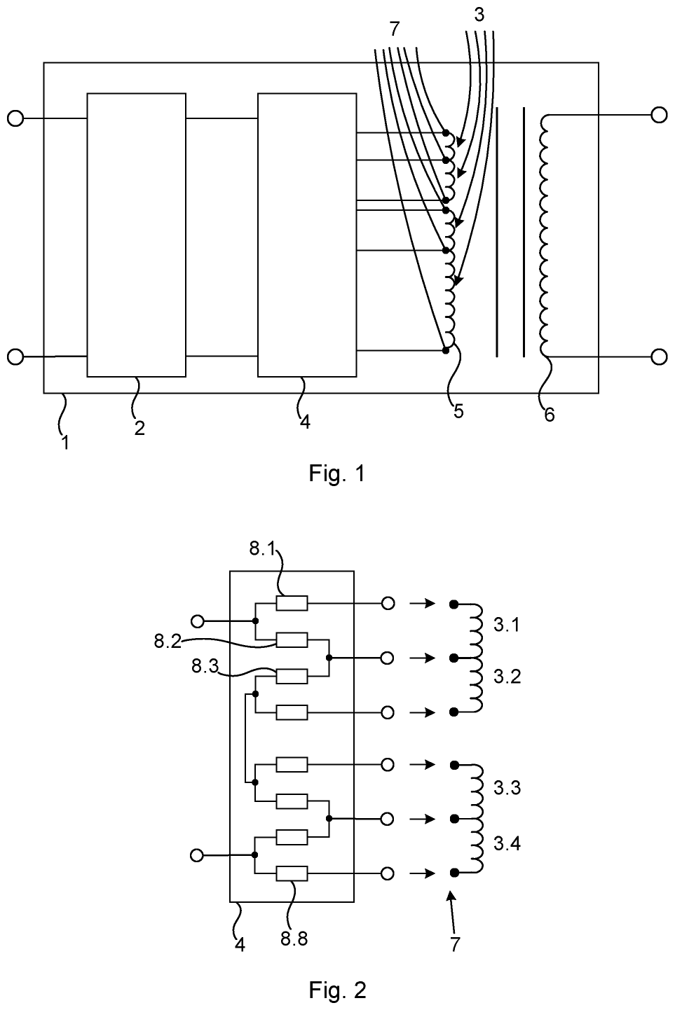

FIG. 1 is a schematic circuit diagram of an inductive power device 1 with variable active winding size, according to an embodiment. The inductive power device 1 comprises first circuitry 2 with two connection terminals extending out of the inductive power device 1 on its left side in the figure. The first circuitry 2 can have any function and any structure; it may be receiving electric energy from the connection terminals or supplying electric energy thereto. In a simple embodiment, the first circuitry 2 may be two electric lines which connect, on the one hand, the left and right upper connection terminals and, on the other hand, the left and right lower connection terminals.

A pair of opposite terminals of the first circuitry 2 can be connected to a variable number of winding segments 3, which are sequential portions of a total winding 5, by means of switching circuitry 4. The winding segments 3 are non-overlapping in this embodiment. The total winding 5 is magnetically coupled to an opposite winding 6. The total winding 5 and opposite winding 6 may be coils on a primary or secondary side of a transformer. The magnetic coupling (or, equivalently, inductive coupling), by which a change in current in one winding induces a voltage across the ends of the other winding, may be achieved by arranging the total winding 5 and the opposite winding 6 in each other's vicinity, in approximate alignment with a common axis. Optionally, as suggested by the double vertical bars, the magnetic coupling may be reinforced by arranging the windings on a common magnetic core.

By way of example, the opposite winding 6 is shown with its endpoints connected directly to connection terminals which extend out of the inductive power device 1 on its right side in FIG. 1. In variations of the depicted embodiment, the opposite winding may instead be connected via second circuitry (not shown) to the corresponding connection terminals. Similar to the first circuitry 2, the second circuitry may have any structure and fulfil any function in the inductive power device 1. In particular, the opposite winding 6 may be structured into winding segments similarly to the total winding 5, with three or more taps, so that selectable combinations of those winding segments can be connected to the second circuitry. For this purpose, switching circuitry analogous to the switching circuitry 4 may be employed.

In the embodiment shown in FIG. 1, there are four winding segments 3. Rather than being a pre-set design characteristic, the combination of winding segments 3 to which the first circuitry 2 is connected is variable during the lifetime of the inductive power device 1, in particular during its operation. In some embodiments, the combination can be changed in an “on-load” condition. The combination of connected winding segments 3, and thereby the active winding size of the inductive power device 1, is selectable by means of the switching circuitry 4, which is responsible for establishing an electric connection of the pair of connection terminals of the first circuitry 2 to a selectable connection of the winding segments 3 via taps 7 of those segments.

As is visible in FIG. 1, the winding segments 3 have uniform polarity with respect to the magnetic coupling to the opposite winding 6, in the sense of having same current direction. This means that the addition of any winding segment 3, when connected to the first circuitry 2 by joining an upper tap of the winding segment 3 to an upper connection terminal of the first circuitry 2 and joining a lower tap of the winding segment 3 to a lower connection terminal of the first circuitry 2, will contribute positively to the total magnetic coupling.

In FIG. 1, several types of taps 7 can be distinguished depending on their connectivity to the winding segments 3. For instance, a tap of the first type connects to a single winding segment, and a tap of the second type is located between two consecutive winding segments and connects to both these winding segments. The switching circuitry 4 is able to include or exclude each winding segment 5 independently if
(C1) there is an arbitrary number of consecutive taps of the first type, and
(C2) any tap of the second type is preceded and followed by at least one tap of the first type.
Condition C2 is equivalent to
(C2′) there are only isolated taps of the second type and is further equivalent to
(C2″) there are no consecutive taps of the second type.

In FIG. 2, which includes a detailed view of the example four winding segments 3.1, 3.2, 3.3, 3.4, the second and fifth taps—located between winding segments 3.1 and 3.2, and between winding segments 3.3 and 3.4, respectively—are taps of the second type. The first, third, fourth and sixth taps are of the first type.

The way in which the switching circuitry 4 selects taps for connecting a combination of selected winding segments depends on the tap types of at the end-points of the selected winding segments as well as the position of a selected winding segment relative to other selected winding segments of the selected combination.

### EXAMPLE 1

To connect any single winding segment 3, the upper and lower taps of that segment shall be connected, respectively, to the pair of connection terminals of the first circuitry 2.

### EXAMPLE 2

The connecting of a combination of two winding segments joined by a tap of the second type is illustrated with reference to the first and second winding segments 3.1, 3.2. Such winding segments may be referred to as adjacent winding segments. The outer endpoints, which correspond to the upper tap of the first winding segment 3.1 and the lower tap of the second winding segment 3.2, shall be joined with a respective connection terminal of the first circuitry 2. The common tap between the first and second winding segments 3.1, 3.2 shall not be connected to the connection terminals.

### EXAMPLE 3

The connecting of a combination of two non-adjacent winding segments is illustrated with reference to the second and third winding segments 3.2, 3.3. To achieve this, the upper tap of the second winding segment 3.2 shall be connected to a first connection terminal of the first circuitry 2; the lower tap of the third winding segment 3.3 shall be connected to a second connection terminal of the first circuitry 2; and further—because the winding segments 3.2, 3.3 are non-adjacent—the lower tap of the second winding segment 3.2 shall be connected to the upper tap of the third winding segment 3.3. By these connections, the second and third winding segments 3.2, 3.3 will effectively be connected in series between the connection terminals of the first circuitry 2. They will constitute the active winding.

### EXAMPLE 4

To connect the full total winding 5, it is sufficient to connect the outer endpoints and establish the interconnection between the second and third winding segments 3.2, 3.3, namely by connecting the lower tap of the second winding segment 3.2 to the upper tap of the third winding segment 3.3. The outer endpoints correspond to the upper endpoint of the first winding segment 3.1 and the lower endpoint of the fourth winding segment 3.4.

A person of ordinary skill in the art having studied these examples will realize how to connect any other combination of the four winding segments 3.1, 3.2, 3.3, 3.4. The skilled person will also be able to determine the tap connections for serially connecting any selectable combination of winding segments as long as the winding segments are provided with taps that fulfil conditions C1 and C2, as stated above.

With continued reference to FIG. 2, there will now be described an example circuit layout of the switching circuitry 4, which comprises an arrangement of switches 8. Not shown in FIG. 2 is an optional controller in or connected to the switching circuitry 4, which controls the switches 8 in dependence of a selected combination of winding segments to be connected.

The switches 8 may be semiconductor switches, such as insulated-gate bipolar transistors (IGBTs) or thyristors (silicon-controlled rectifiers, SCRs), or mechanical switches. The voltage rating of the switches 8 shall be such as to withstand switching impulse overvoltage (SI) and lighting impulse overvoltage (LI), and the current rating shall fulfil the short-circuit (SC) rating of the system. The switches 8 may be arranged as a sequence of interconnected half-bridges or flipping half-bridges. One side (e.g., load side) of the half-bridges are connected to the taps and the other side (e.g., source side) is connected either to the connection terminals towards the first circuitry 2 or to interconnections between consecutive half bridges. In some embodiments, the arrangement of switches 8 fulfils the following conditions:

(C3) Over a winding segment (or, equivalently, pair of consecutive taps), there are two serially connected and independently controllable switches.

(C4) On the serial connection between the two switches over a winding segment, there is either a connection terminal towards the first circuitry 2 or an interconnection towards switches serving a non-adjacent winding segment.

The inventors have realized that if the switching circuitry 4 satisfies conditions C3 and C4 it is able to realize tap connections for connecting, as an active winding, any selectable combination of winding segments 3 to the connection terminals of the first circuitry 2. This assumes that the winding segments 3 have taps 7 that fulfil conditions C1 and C2.

The switching circuitry 4, with eight independently controllable switches 8.1, 8.2, 8.3, . . . , 8.8 connected in the way shown in FIG. 2, satisfies conditions C3 and C4. To realize above Example 2, the switches 8.1, 8.4, 8.6 and 8.7 shall be closed and the remaining switches shall be open. To realize above Example 3, the switches 8.2, 8.4, 8.5 and 8.7 shall be closed and the remaining switches shall be open. To realize above Example 4, the switches 8.1, 8.4, 8.5 and 8.8 shall be closed, and the remaining switches shall be open.

The switching circuitry 4 can be extended in the following manner to serve a larger number of winding segments 3. It is assumed that two further winding segments, joined by a tap of the second type, is added at the lower end of the total winding 5. In such circumstances, the switching circuitry 4 may be extended by a further group of four switches analogous to the upper or lower half of the switching circuitry 4 shown in FIG. 2 and interconnected to the switches which corresponded, before the extension, to the lower half of the switching circuitry 4 of FIG. 2. After the extension, the switches serving the added two winding segments will be connected to the lower connection terminal towards the first circuitry 2. Accordingly, the extended switching circuitry 4 may comprise three groups having four switches each, wherein the first group connects to the upper connection terminal towards the first circuitry 2, the third group connects to the lower connection terminal towards the first circuitry 2, and the second group is interconnected to the first and third groups. The extension procedure can be repeated to obtain a desired size of the switching circuitry 4.

It is noted that the switching circuitry 4 described so far corresponds to a quasi-optimal circuit solution in terms of component cost when there are an even number of winding segments 3 and the taps fulfil conditions C1 and C2. To serve an odd number of winding segments 3, the described circuitry may need to be extended by components arranged in a non-optimal manner. It is seen from Table 1 below that the ratio of taps and winding segments is increased for N equal to 1, 3 and 5. Such mixed arrangements fall within the scope of the present invention. Further optionally, the switching circuitry 4 may be modified in order to cooperate with winding segments 3 that are not provided with taps fulfilling conditions C1 and C2.

As already stated, the winding segments 3.1, 3.2, 3.3, 3.4 have respective sizes B₁, B₂, B₃, B₄, from which at least two are unequal. In some embodiments, the sizes of N winding segments 3.1, 3.2, . . . , 3. N are proportional to successive powers of 2, such as Bₙ=2^{N}^{ₒ₊ₙ}M, where n=1,2, . . . , N and M, No are arbitrary integers. An active winding size of pM, with p integer, can then be realized by connecting a combination of the winding segments corresponding to the true bits (possibly shifted) in the binary expansion (b_{N} . . . b₂b₁b₀)₂ of p, which satisfies p=Σₙ₌₀^{N}bₙ2ⁿ. A set of winding segments with this size distribution covers the range [0,(2^{N}^{₀}^{+N+1}−1)M] with a step of 2^{N}^{₀}⁺¹M.

In the special case M=1 and N₀=−1, the step is 1. The scaling behaviour with respect to N is as given in Table 1:

TABLE 1

| Number of winding segments | 1 | 2 | 3 | 4 | 5 | 6 | N |
|---|---|---|---|---|---|---|---|
| Maximum winding segment size | 1 | 2 | 4 | 8 | 16 | 32 | 2^{N-1} |
| Number of steps in range | 2 | 4 | 8 | 16 | 32 | 64 | 2^{N} |
| Number of switches | 2 | 4 | 6 | 8 | 10 | 12 | 2N |
| Number of taps | 2 | 3 | 5 | 6 | 8 | 9 | q(N) |

The number of taps for N winding segments is q(N) 32 3 floor(N/2)+2 mod(N, 2).

In an example implementation of the embodiment shown in FIG. 2, the inductive power device 1 has sixteen steps, six taps 7 per phase and eight power electronics switches 8. Thyristors are used as switches, with a total voltage rating of 2×30×Vₛₜₑₚ, where Vₛₜₑₚ is the voltage difference corresponding to winding segment combinations separated by one step. The short-circuit current rating of the device 1 is 20 kA for a duration of 3 seconds.

Powers of 2 may correspond to an optimal size distribution of the winding segments 3. Indeed, if the natural numbers are regarded as a vector space over the binary numbers then, because every integer has a unique binary expansion, the powers of 2 constitutes a basis. A further useful embodiment provides an inductive power device 1 wherein sizes of the winding segments include a sequence of successive powers of 2 but also one or more redundant elements, such as a winding segment size of 3 in the set S={1, 2, 3, 4, 8}. All integers which the set S\ {8} spans — that is [0, 15]—are also spanned by the set S. However, some integers have a non-unique representation in terms of the element of S. The number 5 is one example, since 5=1+4=2+3. In terms of the inductive power device 1, this corresponds to an implementation where a desired active winding size can be obtained by any of two selectable combinations of winding segments, which—considered in isolation—suggests a structural redundancy. An inductive power device 1 where the winding segments 3 have this or a similar size distribution may however be justified by design constraints or other considerations, and as long as all features of the invention are fulfilled the inductive power device 1 remains an embodiment thereof.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. An inductive power device with variable active winding size, comprising:
first circuitry;
at least two winding segments; and
switching circuitry operable to connect selectable combinations of said winding segments serially to the first circuitry, characterized in that at least two of the winding segments are of unequal size, wherein said at least two winding segments are provided as sequential portions of a total winding magnetically coupled to an opposite winding, wherein the winding segments have uniform polarity with respect to said magnetic coupling.

2. The inductive power device of claim 1, wherein the winding segments are located between consecutive taps of the total winding.

3. The inductive power device of claim 1, wherein:
the taps comprise taps of a first type, which connect to a single winding segment, and taps of a second type, which are located between consecutive winding segments and connect to both these winding segments; and
there are no consecutive taps of the second type.

4. The inductive power device of claim 1, wherein the winding segments are non-overlapping.

5. The inductive power device of claim 1, wherein the switching circuitry is arranged to connect each of the selectable combinations of said winding segments to a pair of connection terminals of the first circuitry.

6. The inductive power device of claim 5, wherein the switching circuitry comprises an arrangement of switches operable to include or exclude each winding segment independently.

7. The inductive power device of claim 6, wherein the switches in the arrangement are semiconductor switches, such as thyristors, or mechanical switches.

8. The inductive power device of claim 5, wherein the switching circuitry comprises at least one half-bridge arrangement.

9. The inductive power device of claim 5, wherein the switching circuitry satisfies:
over a winding segment, there are two serially connected and independently controllable switches; and
on the serial connection between the two switches over a winding segment, there is either a connection terminal towards the first circuitry or an interconnection towards switches serving a non-adjacent winding segment.

10. The inductive power device of claim 5, wherein the switching circuitry is an on-load tap changer.

11. The inductive power device of claim 1, wherein the sizes of the winding segments are proportional to a sequence of factors which includes successive powers of 2.

12. The inductive power device of claim 11, wherein the sizes of the winding segments are proportional to successive powers of 2.

13. The inductive power device of claim 1, which is a transformer.

14. The inductive power device of claim 2, wherein:
the taps comprise taps of a first type, which connect to a single winding segment, and taps of a second type, which are located between consecutive winding segments and connect to both these winding segments; and
there are no consecutive taps of the second type.

15. The inductive power device of claim 2, wherein the winding segments are non-overlapping.

16. The inductive power device of claim 3, wherein the switching circuitry is arranged to connect each of the selectable combinations of said winding segments to a pair of connection terminals of the first circuitry.

17. The inductive power device of claim 5, wherein the switching circuitry comprises an arrangement of switches operable to include or exclude each winding segment independently.

18. The inductive power device of claim 7, wherein the switching circuitry satisfies:
over a winding segment, there are two serially connected and independently controllable switches; and
on the serial connection between the two switches over a winding segment, there is either a connection terminal towards the first circuitry or an interconnection towards switches serving a non-adjacent winding segment.

19. The inductive power device of 18, wherein the switching circuitry is an on-load tap changer.

20. The inductive power device of claim 9, wherein the sizes of the winding segments are proportional to a sequence of factors which includes successive powers of 2.
